(19) United States
(12) Patent Application Publication
(10) Pub. No.: US 2026/0355862 A1
(43) Pub. Date: Nov. 12, 2026

(54) LASER WELDING TORCH

(71) Applicant: Lincoln Global, Inc., Cleveland, OH (US)

(72) Inventors: Christopher D. Agosti, Mentor, OH (US); Kyle G. Smith, Kirtland, OH (US); Kevin Fleming, Saranac, MI (US); Ian F. Lind, Eastlake, OH (US)

(21) Appl. No.: 19/561,739

(22) Filed: Mar. 10, 2026

Related U.S. Application Data
(60) Provisional application No. 63/770,471, filed on Mar. 12, 2025.

(51) Int. Cl. B23K 26/348; B23K 9/10; B23K 9/133; B23K 26/06; B23K 26/064; B23K 26/142; B23K 37/02; B25J 15/00

(52) U.S. Cl. CPC B23K 26/348; B23K 9/1093; B23K 9/133; B23K 26/0643; B23K 26/0648; B23K 26/0665; B23K 26/142; B23K 37/0229; B25J 15/0019

(57) ABSTRACT

A laser welding torch for a through-arm robot includes a housing and a neck. The housing includes internal optics therein configured to irradiate a laser beam, and a neck attached to a distal end of the housing. The neck includes a first portion and a second portion that is skewed relative to the first portion. The neck is configured to redirect the laser beam from a first axis extending through the first portion to a second axis extending through the second portion.

### CROSS REFERENCE TO RELATED APPLICATION

This application claims the benefit of U.S. provisional patent application No. 63/770,471, filed on Mar. 12, 2025, the contents thereof which are fully incorporated herein by reference.

### FIELD

The present disclosure generally relates to welding torches, and more specifically, a laser welding torch including integrated laser, wire, power, cooling, and shielding gas utilities for performing robotic laser welding across a greater variety of joint types and part geometries.

### BACKGROUND

Laser welding is a precise method for joining materials with minimal spatter and slag that can be performed at very high speeds, making it desirable for mass-production environments. Laser welding applications are sometimes automated to increase productivity, repeatability, and safety. A conventional automated laser welding system includes a robot with a processing head mounted to a distal end of a robot wrist. The processing head generally includes a laser optics housing configured to focus and irradiate a laser beam. If the addition of filler material is required, the system may also include a wire feeding apparatus configured to feed welding wire into the path of the laser beam. Conventional robotic laser welding systems are unsuitable for certain applications where welding joint access is confined or where part geometries are complex due to the weight and size of the processing head. In addition to these limitations, such laser processing heads are incompatible with newer reduced-wrist-capacity conventional welding robots that provide streamlined cable routing arrangements, e.g., through-wrist robots. It is desirable to provide a laser robotic welding solution that addresses the foregoing deficiencies.

### SUMMARY

The following summary presents a simplified summary in order to provide a basic understanding of some aspects of the devices and systems described herein. This summary is not an extensive overview of the devices and systems described herein, and is not intended to identify critical elements or to delineate the scope of such devices or systems. Its sole purpose is to present some concepts in a simplified form as a prelude to the more detailed description that is presented later.

In accordance with one aspect, there is provided a laser welding torch for a through-arm robot. The laser welding torch includes a housing having a laser optics assembly therein. The laser optics assembly is configured to irradiate a laser beam along a first axis. The laser welding torch also includes a neck attached to a distal end of the housing. The neck includes a first portion and a second portion that is skewed relative to the first portion. The neck is configured to redirect the laser beam from a first axis to a second axis extending through the second portion.

In an embodiment, the second axis of the neck defines a convergence angle with the wire delivery axis that is between about 3° and 60°.

In an embodiment, the second portion includes a contact tip at a distal end thereof that is configured to direct welding wire to a weld along a wire delivery axis.

In an embodiment, the neck is removably attached to the housing.

In an embodiment, the laser optics assembly includes a collimation lens configured to convert a diverging laser beam into a collimated laser beam, and a focusing lens configured to adjust a spot size of the laser beam.

In an embodiment, the housing includes a first input device configured to adjust a position of the collimation lens within the housing, and a second input device configured to adjust a position of the focusing lens within the housing.

In an embodiment, the laser optics assembly includes a protective enclosure that embodies a replaceable cartridge that includes at least one of a collimation lens and/or a focusing lens.

In an embodiment, the housing defines an internal cavity and includes a protective cover lens. The protective cover lens is configured to prevent contamination of the internal cavity.

In an embodiment, the housing includes a purge gas inlet in fluid communication with an internal cavity of the housing, and the housing is sealed to maintain a positive internal pressure to inhibit dust and debris from contaminating the laser optics assembly.

In an embodiment, the neck includes a retaining collar configured to engage a distal end of the housing to secure the neck thereto.

In an embodiment, the neck includes an inlet configured to receive gas to purge a lower portion of the neck and/or to supply the gas through a nozzle located proximate a distal end of the neck to protect the weld from atmospheric contaminants.

In an embodiment, the neck includes at least one reflective optical element therein configured to redirect the laser beam from the first axis to the second axis.

In an embodiment, the neck includes a first reflective optical element configured to redirect the laser beam from the first axis to the second axis, and a second reflective optical element configured to redirect the laser beam from the second axis to a third axis.

In an embodiment, at least one of a wire conduit, a fiber optic cable, a gas supply line, a power cable, a coolant line, or a sensor lead is routed along an exterior surface of the housing or the neck and is secured thereto by a mount, clip, strap, or shroud.

In an embodiment, the laser welding torch also includes a gas flow device configured to direct a gas flow across at least one of an optical opening, a cavity of the housing, or a cavity of the neck to inhibit ingress of contaminants into at least one of the cavity of the housing or the cavity of the neck.

In accordance with another aspect, a welding torch includes a housing defining an internal cavity with at least one optical element therein. The at least one optical element is configured to irradiate a laser beam therefrom. The welding torch also includes a neck removably attached to the housing. The neck is configured to direct the laser beam toward a weld.

In an embodiment, the neck is aligned colinearly with the housing along a longitudinal axis of the welding torch.

In an embodiment, the neck includes a bent portion configured to supply welding wire to the weld.

In an embodiment, the neck includes a first portion and a second portion that may be extended or retracted relative to the first portion to vary a focal position of the laser beam at the weld.

In an embodiment, the neck also includes a contact tip configured to direct welding wire to the weld and apply current thereto.

In an embodiment, the contact tip is removably attached to the neck via a mount, and the mount is configured to be repositioned about a circumference of the neck.

In an embodiment, the neck includes at least one of a mirror or focusing lens therein.

In an embodiment, the neck includes a wire conduit and a contact tip configured to direct welding wire supplied via the wire conduit toward the weld.

In an embodiment, the neck also includes a power cable configured to supply current to a contact tip to preheat welding wire or establish an arc.

In an embodiment, the neck defines an optical aperture such that the welding torch is configured to irradiate the laser beam through the optical aperture.

In accordance with another aspect, a torch for welding includes an optical element therein. The optical element is configured to direct a laser beam toward a weld. The torch also includes a neck removably attached to the housing. The neck includes a contact tip at a distal end thereof. The contact tip is configured to resistively preheat a wire or establish an arc between the wire and the weld.

In an embodiment, the torch is configured to perform at least two of autogenous laser welding, cold wire laser welding, hot wire laser welding, hybrid-laser-arc-welding (HLAW), and gas metal arc welding (GMAW).

In an embodiment, the torch is configured to operatively connect to a power source and is configured to (i) deliver welding wire to a weld without preheating the welding wire to perform cold-wire laser welding, (ii) resistively preheat the welding wire to perform hot-wire laser welding, or (iii) establish to perform gas metal arc welding (GMAW) and/or hybrid-laser arc welding (HLAW).

In an accordance with another aspect, a laser welding torch for a through-arm robot includes a housing containing a laser optics assembly, and a neck attached to a distal end of the housing. The laser optics assembly is configured to emit a laser beam along a first axis, and at least one optical element in the neck is configured to redirect the laser beam toward a weld along a second axis defined by a skewed second portion of the neck. A contact tip may be aligned with the redirected beam and configured to deliver welding wire with a reduced beam-to-wire convergence angle and improved access in confined joints. Utilities such as fiber-optic, wire, power, and gas may be routed through the robot wrist, and the housing includes contamination-control features such as a cover glass and transverse gas flow. In some embodiments, the optics are provided as a replaceable cartridge, and the torch is operable across multiple welding modes using a common hardware configuration.

Numerous aspects of the general inventive concepts will become readily apparent from the following detailed description of exemplary embodiments, from the claims, and from the accompanying drawings.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a perspective view of an example robotic laser welding system;

FIG. 2 is a perspective view of an example robotic laser welding system according to the present disclosure;

FIG. 3 is a side view of an example robotic laser welding torch according to the present disclosure;

FIG. 4 is a sectional view of the robotic laser welding torch of FIG. 3;

FIG. 5A is a partial, perspective view of a distal end of an example neck of a robotic laser welding torch according to another embodiment;

FIG. 5B is a closeup view of the area demarcated by a dotted circle labeled 5B in FIG. 5A;

FIG. 5C is a partial, perspective view of the distal end of an example neck of a robotic laser welding torch according to another embodiment;

FIG. 6 is a side view of an example robotic laser welding torch according to another embodiment, wherein the robotic laser welding torch includes an example wire guide assembly according to an embodiment;

FIG. 7 is a partial, perspective view of an example neck and optical arrangement for an example robotic laser welding torch according to an embodiment;

FIG. 8 is a partial, perspective view of another example neck and optical arrangement for another example robotic welding torch according to an embodiment;

FIG. 9 is a partial, perspective view of another example neck and optical arrangement for another example robotic laser welding torch according to an embodiment, wherein the neck is shown as partially transparent to illustrate internal components thereof;

FIG. 10 is a partial, perspective view of another example neck and optical arrangement for another example robotic laser welding torch according to an embodiment;

FIG. 11 is a partial, perspective view of another example neck and optical arrangement for another example robotic laser welding torch according to an embodiment;

FIG. 12 is a partial, perspective view of another example neck and optical arrangement for another example robotic laser welding torch according to an embodiment, wherein the neck is shown as partially transparent to illustrate internal components thereof;

FIG. 13 is a partial, perspective view of another example neck and optical arrangement for another example robotic laser welding torch according to an embodiment, wherein the neck is shown as partially transparent to illustrate internal components thereof; and

FIG. 14 is a partial perspective view of another example neck and optical arrangement for another example robotic laser welding torch according to an embodiment;

FIGS. 15A and 15B depict example wire feeding arrangements for a robotic laser welding torch according to embodiments;

FIG. 16A is a side view of another example robotic laser welding torch according to an embodiment;

FIG. 16B is a sectional view of the robotic laser welding torch of FIG. 16A;

FIG. 16C is a side view of another example robotic laser welding torch according another embodiment; and

FIG. 17 is sectional view of a distal end of a wrist of the robot of FIG. 2 taken along line 17-17.

### DETAILED DESCRIPTION

The present disclosure will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating an understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together. Any disjunctive word or phrase presenting two or more alternative terms, whether in the description of embodiments, claims, or drawings, should be understood to contemplate the possibilities of including one of the terms, either of the terms, or both terms. For example, the phrase “A or B” should be understood to include the possibilities of “A” or “B” or “A and B.”

Herein, the terms “substantially,” “about,” and variations thereof are intended to note that the described features are equal or approximately equal to a value or characteristic, as desired, reflecting tolerances, conversion factors, rounding off, measurement error and the like, and other factors. For example, the terms “substantially”, “about”, and variations thereof can denote values or characteristics that are exact or within 10% of exact, for example within 5% of exact, or within 2% of exact.

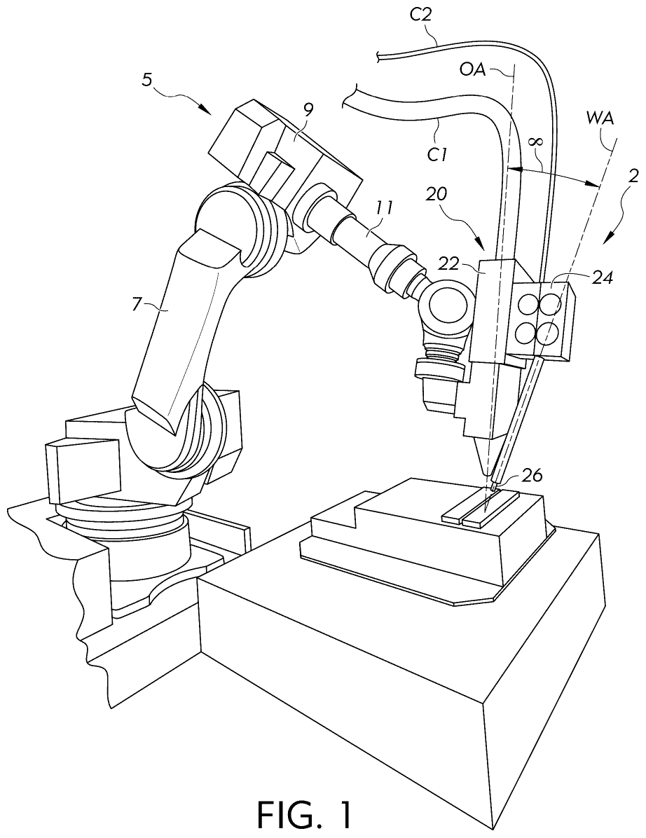

Referring to FIG. 1, an example of a robotic laser welding system 2 is shown. The robotic laser welding system 2 includes a robot 5 with first and second articulating arms 7 and 9, respectively, and a wrist 11 extending from the second arm 9. A processing head 20 is arranged at a distal end of the wrist 11 and includes a laser optics housing 22 and a wire feeding apparatus 24. The laser optics housing 22 is configured to focus and irradiate a laser beam along an optical axis OA, and the wire feeding apparatus 24 is configured to supply welding wire to a path of the laser beam. In the example shown, the wire feeding apparatus 24 is configured to supply wire along a wire delivery axis WA that defines an acute convergence angle ∞ with the optical axis OA of the laser beam.

A first conduit C1 operatively connects the laser optics housing 22 to a laser source, for example, a photon beam laser oscillator (not shown). The first conduit C1 may comprise a fiber optic cable assembly for transmitting laser light from the laser source to the laser optics housing 22. A second conduit C2 operatively connects the wire feeding apparatus 24 to an external wire supply source (not shown). The second conduit C2 may also comprise a wire conduit (e.g., a liner defining a low-friction cavity) for conveying welding wire from the external wire supply source to the wire feeding apparatus 24. The second conduit C2 may also comprise other utilities, for instance, an insulated power cable to supply current to a contact tip 26 to resistively preheat the welding wire (e.g., to facilitate hot wire laser welding), and a shielding gas conduit to supply shielding gas to the weld (to protect the weld from contaminants in the environment). In other embodiments, the contact tip 26 may supply current to the welding wire to perform a GMAW process or a HLAW process (e.g., wherein a welding arc is established between the contact tip and the weld while a laser beam is concurrently directed toward the weld).

As shown in FIG. 1, the processing head 20 occupies a substantial amount of space, namely due to the respective sizes of the optics housing 22 and the wire feeding apparatus 24. The space occupied by the processing head 20 and the optics housing 22 limits the robot's ability to effectively laser weld in confined spaces or perform laser welding on complex part geometries. Moreover, the exposed conduits C1 and C2 extending from the processing head 20 are susceptible to being entangled with other elements in the environment (e.g., part fixtures, the workpiece, etc.), further reducing the available work envelope of the laser welding robot.

Furthermore, because the laser optics housing 22 and the wire feeding 24 are disposed in an adjacent relationship (i.e., next to each other), it follows that the convergence angle ∞ between the optical axis OA and wire delivery axis WA must exceed a minimum threshold. This minimum angle is expansive and thereby limits the type of applications that the laser welding robot can perform, e.g., laser welding in confined spaces or on complex part geometries. In addition, the expansive convergence angle ∞ inhibits the processing head 20 from performing omnidirectional movement (e.g., omnidirectional path movement, or omnidirectional rotation around a centerline axes).

Further still, transitioning from a conventional robotic arc welding application (e.g., robotic Gas Metal Arc Welding (GMAW)) to a laser welding application poses many challenges, namely because a robotic arc welding application has an arc emission axis and a wire feeding axis that are substantially the same, or that define a very small convergence angle therebetween (e.g., less than about 5°), in contrast to the expansive convergence angle ∞ between the laser beam path (i.e., optical axis OA) and wire delivery axis WA discussed above. These differences require extensive reprogramming and fixturing redesign, particularly in view of the need to account for different wire entry angles, and differences in the size, shape, and weight of the welding equipment required (e.g., differences in size/shape/weight between a laser processing head size and a robotic GMAW welding gun). Moreover, the size and weight of the laser processing head 20 precludes the possibility of utilizing a robot with enhanced cable arrangement features, e.g., a through-wrist robot, wherein cables are routed through the wrist of a robot.

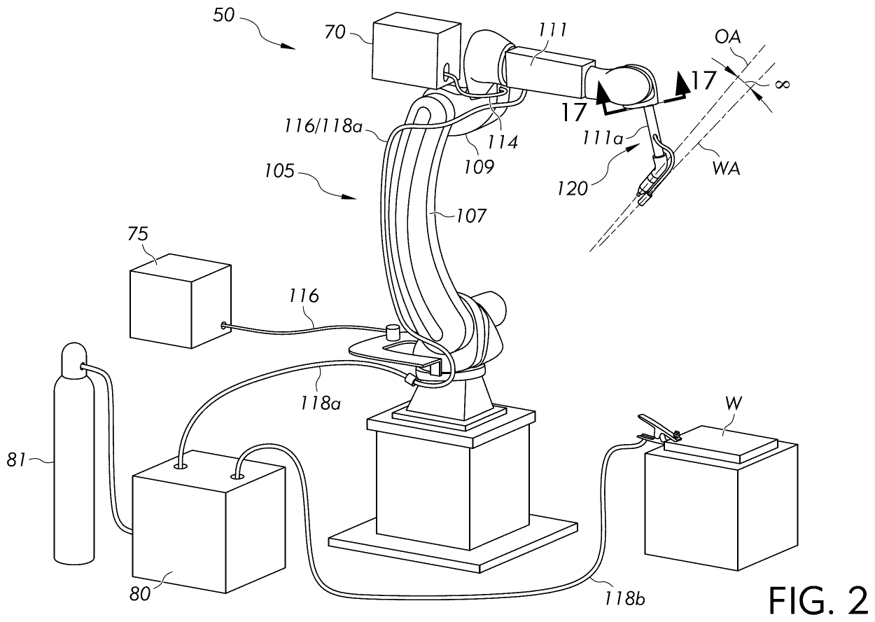

Referring now to FIG. 2, an example robotic welding system 50 according to an embodiment of the present disclosure is shown. In general, the system 50 includes a wire feeder 70, a laser oscillator 75, a power source 80, a robot 105, and an example laser welding torch 120 according to an embodiment. The robot 105 includes first and second articulating arms 107 and 109, and a wrist 111 extending from the second arm 109. In the embodiment shown, the wrist 111 defines a channel therethrough (not shown) extending between opposing ends thereof. In this manner, wrist 111 is configured to receive utility cables therethrough (e.g., fiber optic cables, wire conduits, power cables, sensor leads, air lines, etc.), as discussed in detail below.

The wire feeder 70 is configured to supply welding wire to the laser welding torch 120 via a wire conduit 114 extending through the wrist 111 of the robot 105. For this purpose, the wire feeder 70 may include a drive motor (not shown) operable to actuate drive rolls (therein) to grip and push the welding wire through the wire conduit 114 connected to the laser welding torch 120. The wire feeder 70 may take on any suitable form, for example, a push-pull wire feeder (e.g., a four-roll wire drive configured to pull welding wire from an external wire supply source (e.g., a drum of wire)), and push the welding wire through the wire conduit 114 extending between the torch 120 and the wire feeder 70.

The laser oscillator 75 (schematically shown) is configured to generate a laser beam that is supplied to the laser welding torch 120 via a flexible, fiber optic cable 116 extending between the laser oscillator 75 and the laser welding torch 120. The laser oscillator 75 may include an energy source (e.g., a pump source) to generate photons that are reflected therein (e.g., via a resonant cavity) to intensify the laser light beam supplied to the laser welding torch 120.

The power source 80 (schematically shown) is configured to supply current to the laser welding torch 120 and may take on any suitable form, e.g., a constant current/constant voltage power source or a constant power welding power source. The power source 80 may also be configured to supply shielding gas to the laser welding torch 120 (received from a shielding gas supply 81). For this purpose, a power cable/gas supply lead 118a may operatively connect the power source 80 to the laser welding torch 120 to supply current and shielding gas thereto. A work lead 118b may be routed from the power source 80 to the workpiece to establish a heating or welding circuit, as discussed below. In some embodiments, the power cable/gas supply lead 118a may be provided as separate leads, for example, a power cable lead operatively connected to the power source 80 to supply current to the laser welding torch 120, and a gas supply lead operatively connected to the gas supply source 80 to supply shielding gas to the laser welding torch 120. In some embodiments, the power cable/gas supply lead 118a may also comprise coolant lines (for circulating coolant to laser optics inside the laser welding torch 120 (e.g., to cool one or more mirrors) or to provide cooling to the laser welding torch 120, for example, when using the laser welding torch 120 to perform a robotic GMAW process). In some embodiments, it is contemplated that the laser optics inside the torch may be cooled via other means, for example, via thermoelectric cooling (e.g., using the Peltier effect), or via natural or forced air convection.

As shown in FIG. 2, the fiber optic cable 116, the wire conduit 114, and the power cable/gas supply lead 118a are routed through the wrist 111 of the robot 105 (as opposed to being externally routed). This aspect of the present disclosure is beneficial insofar as it reduces the likelihood of the utility cables (e.g., the fiber optic cable 116, the wire conduit 114, and the power cable/gas supply lead 118a) from becoming entangled with objects surrounding the wrist 111 and the laser welding torch 120, for instance, when the wrist 111 and the laser welding torch 120 are moved or otherwise manipulated during a laser welding process.

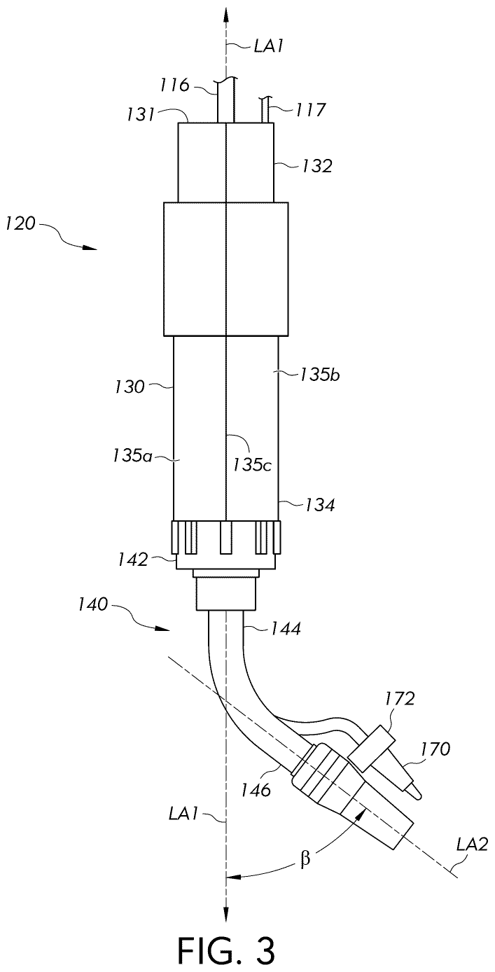

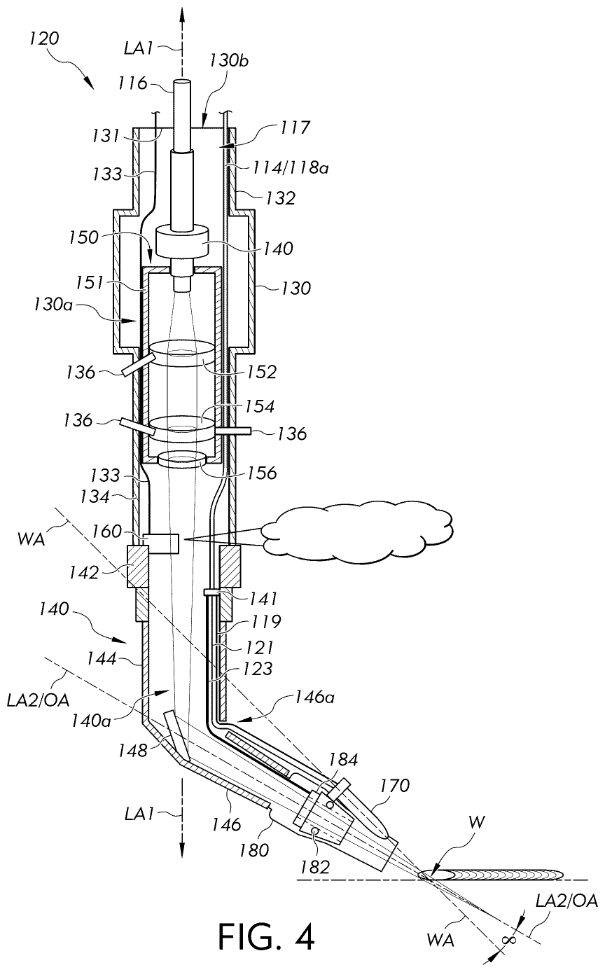

As shown in FIGS. 3 and 4, the laser welding torch 120 includes a housing 130 and a neck 140 connected to a distal end 134 of the housing 130. The housing 130 may be made from a suitable rigid material (e.g., stainless steel, aluminum, or molded plastic suitable for exposure to high-temperatures, e.g., PTFE, polyamide, acrylic, etc.). In the embodiment shown, the housing 130 is a cylindrical housing. It is contemplated that the housing 130 may take on other shapes and forms, e.g., a square-shaped housing, a rectangular-shaped housing, etc.

As shown in FIG. 4, the housing 130 defines a cavity 130a therein dimensioned to receive utility cables (e.g., the fiber optic cable 116, the wire conduit 114, the power cable/gas supply lead 118a, and an air supply lead 133) and a laser optics assembly 150 therein. In some embodiments, a cushioning material may be disposed in the housing 130 to reduce shock, for example, a rubber, polyurethane foam, EPS, or expanded polyethylene, etc. In the embodiment shown, the wire conduit 114 and the power cable/gas supply lead 118a form part of a utility cable bundle 117. It should be appreciated that the utility cable bundle 117 may also comprise other utilities, for example, coolant lines for circulating coolant to the torch 120 and/or to optical components (e.g., reflective mirrors) therein, sensor leads (e.g., for collision detect sensors), and/or communication leads (e.g., for a camera or a scanner, etc.).

In some embodiments, some of the aforesaid utilities may be routed as separate cables (e.g., separate leads, conduits, hoses, or lines, etc.) as opposed to being part of a utility cable bundle 117. In some embodiments, the utility cable bundle 117 and some of the utility cables (e.g., the power cable lead) may be electrically insulated via a protective shroud, for example, a shroud made of rubber or a thermoplastic material.

The utility cable bundle 117, the fiber optic cable 116, and the air supply lead 133 may be introduced into the housing 130 via openings 130b extending through a mounting interface 131 of the housing 130. The mounting interface 131 may be shaped and dimensioned to engage a mounting flange disposed at a distal end 111a (FIG. 2) of the robot wrist 111 (FIG. 2). In some embodiments, the mounting interface 131 may define openings to receive fasteners (e.g., bolts) to secure the laser welding torch 120 to the wrist 111, i.e., to the mounting flange thereof. Although it should be understood that the laser welding torch 120 may be secured to the wrist 111 in other ways, for example, via any other suitable attachment means for this purpose, e.g., a retaining collar or retaining nut, spring loaded pins devised to engage openings in the wrist, set screws, and the like.

Referring to FIG. 3, the housing 130 may comprise two halves 135a and 135b that may be removably attached via fasteners (e.g., screws, bolts, snaps, clevis pins, detent pins, spring-loaded pins, clasps, or any other suitable fastening means). In some embodiments, the halves 135a and 135b may be connected via a hinge 135c defining a pivot axis 135c, enabling one half of the housing 130 (e.g., one of 135a and 135b) to pivot relative to the other half (the other of 135a and 135b). In this manner, a user may access the cavity 130a and the components therein (e.g., optics assembly 150, the utility cable bundle 117, etc.) by removably disengaging the fasteners securing the halves 135a and 135b of the housing 130, or by pivoting one half relative to the other).

Referring to the example of FIG. 4, the laser optics assembly 150 is configured to collimate and focus the laser beam exiting the fiber optic cable 116. In the embodiment shown, the fiber optic cable 116 is connected to the laser optics assembly 150 via a coupler 140, for example, a fiber bayonet coupler, or any other suitable means, e.g., a QBH fiber cable receiver, and the like.

In some embodiments, the laser optics assembly 150 may include a protective enclosure 151 configured to accommodate and protect the internal optics therein from the external environment (e.g., from dust or particulate exposure). In some embodiments, the protective enclosure 151 may embody a cartridge or sub-assembly that may be replaced by the user, for example, by opening the housing 130 to access the cavity 130a as discussed above. Although in other embodiments, the protective enclosure 151 may be omitted, for example, in those embodiments wherein the housing 130 is purged with a purge gas. The internal optics may include at least one of a first optical element and a second optical element. The first optical element may comprise a collimation lens 152 and the second optical element may comprise a focusing lens 154 located downstream of the collimation lens 152. Although other arrangements are contemplated, as discussed below. For instance, in certain embodiments, the internal optics may only comprise one optical element (e.g., a collimation lens), wherein a second optical element may be located in the neck 140.

As shown in FIG. 4, the collimation lens 152 may be configured to convert a diverging laser beam emitted from the fiber optic cable 116 (exiting an outlet of the coupler 140) into a collimated (parallel) laser beam having an intensified energy density. In some embodiments, one or more input devices 136 (e.g., adjusting screws, sliders, knobs and the like) may be operatively connected to the collimation lens 152 to adjust a position of the collimation lens 152 relative to the source of the laser beam (e.g., relative to an outlet of the coupler 140), for example, when it is desired to fine tune the laser beam, or modify the beam diameter and/or divergence angle. The input devices 136 may extend through a wall of the enclosure 151 and through a wall of the housing 130 so as to be accessible by the user to adjust an axial position of the collimation lens 152 (in a direction parallel to a longitudinal axis LA1 of the laser welding torch, or to adjust a lateral position of the collimation lens 152 (e.g., in a direction perpendicular to the longitudinal axis LA1). The focusing lens 154 may be configured to concentrate the laser beam emitted from the collimation lens 152 to adjust the laser beam diameter (e.g., to a reduced beam diameter) while further increasing the energy density of the laser beam. That is, the focusing lens is configured to cause the collimated laser beam to begin converging toward a focal point at a focal length FL, at which the beam waist is at its minimum. In this manner, the focusing lens 154 may be configured to adjust the spot size of the laser beam at the weld site W (i.e., where the beam is incident upon the substrate or workpiece to form a molten weld puddle). In some embodiments, this location corresponds to the point at which the laser beam intersects the wire positioned on the workpiece.

One or more input devices 136 (e.g., adjusting screws, sliders, knobs, and the like) may also be operatively connected to the focusing lens 154, for example, when it is desired to fine tune the laser beam (e.g., the alignment and placement thereof). The input devices may extend through the wall of the enclosure 151 and through the wall of the housing 130 so as to be accessible by the user to adjust an axial position of the focusing lens 154 (e.g., in a direction parallel to the longitudinal axis LA1), or a lateral position thereof (e.g., in a direction perpendicular to the longitudinal axis LA1). It is contemplated that other examples of adjusting means may be provided to adjust the collimation lens 152 and/or the focusing lens 154, for example, a micrometer, a piezo actuator, a tilt mount, an electric linear actuator, a stepper motor, or a threaded mount, etc.

A protective cover lens 156 (e.g., a cover glass) may be disposed at a distal end of the protective enclosure 151 to prevent contamination of the enclosure 151 cavity (i.e., to protect the internal optics from the external environment), while providing a transparent passage for the laser beam to pass through.

In some embodiments, the laser welding torch 120 may be operatively connected to an external air supply (e.g., an oil-free compressor with a moisture separator) via the air supply lead 133 to supply purge air through the cavity 130a of the housing 130, e.g., to maintain a positive pressure therein (e.g., less than about 10 psig) for preventing contaminants (e.g., dust or particulate in the environment) from entering the housing 130. In some embodiments, a regulator may be provided to reduce the pressure of the air supplied to the housing 130 via the air line 133 for this purpose, e.g., via a miniature pressure regulator. In other embodiments, a compressed gas source (e.g., inert Nitrogen) may be utilized to maintain a positive pressure in the housing 130.

As shown in FIG. 4, in some embodiments, the air supply lead 133 may extend from a proximal end 132 of the housing toward the distal end 134 thereof to supply air to a gas flow device 160 configured to emit a high-velocity air stream in a direction perpendicular to the longitudinal axis LA1 of the laser welding torch 120. In particular, the gas flow device 160 may be configured such that it directs an air stream from one side of the cavity 130a (in direction perpendicular to the longitudinal axis LA1) to the other side thereof to preclude contaminants from the external environment from reaching the protective cover lens 156 and the internal optics of the optics assembly 150. In some embodiments, the gas flow device 160 may comprise a nozzle or an air knife (or another suitable form) defining a slot and/or a small hole that is dimensioned to direct a high-velocity air stream.

Referring to FIGS. 3 and 4, the neck 140 may include a retaining collar 142 configured to engage the distal end 134 of the housing 130. In some embodiments, the retaining collar 142 may define an interior thread pattern dimensioned to rotatably engage a mating thread pattern on an exterior surface of the housing 130, respectively, to attach the neck 140 to the housing 130. It is contemplated that the neck 140 may be attached to the housing 130 in different ways, for example, via resilient snaps, clips, bayonet connectors, cam locks, dovetail slides or keyed joints, etc.

As shown in FIG. 3, the neck may include a first portion 144 and a second portion 146 bent or skewed from the first portion 144. The second portion 146 may define an angle β between the longitudinal axis LA1 of the torch that is between about 15° and 90°, for example, about 22°, about 30°, about 45°, about 60°, or about 80°. Moreover, the neck 140 may be removed from the housing 130 by rotatably disengaging the retaining collar 142 from the housing 130, for example, when it is desired to replace the neck 140 with another neck (defining another angle β). For instance, a first neck may define about a 22° angle β, a second neck may define about a 30° angle β, a third neck may define about a 45° angle β, a fourth neck may define about a 60° angle β, and a fifth neck may define about a 60° angle β. Although it is envisioned that other neck configurations may be provided to define other angles β other than those described herein.

As shown in FIG. 4, the neck 140 may comprise a utility connection interface 141 to connect the utilities supplied through the housing 130 (supplied via the utility cable bundle 117) to the associated utilities in the neck 140. The utility connection interface 141 may comprise threaded connectors, quick connect fittings (e.g., push-in fittings), a suitable sealing means (e.g., o-rings, heat-shrink tubing, silicone seals, etc.), an insulating means (e.g., PVC, teflon, heat shrink insulation, epoxy coating, ceramic insulators, and the like), and check valves as needed (e.g., to prevent reverse coolant or shielding gas flow).

In some embodiments, the neck 140 may comprise a removable wire conduit 119 (e.g., a removable liner) that connects to the utility cable bundle 117 cable (e.g., to the wire conduit 114 thereof) at the connection interface 141. Likewise, the neck 140 may comprise a power cable 121 configured to connect to the utility cable bundle 117 (e.g., to the power cable/gas supply lead 118a thereof) at the connection interface 141. Further still, the neck 140 may comprise a gas supply lead 123 (e.g., a hose) configured to connect to the utility cable bundle 117 (e.g., to the power cable/gas supply lead 118a thereof) at the connection interface 141. In some embodiments, the wire conduit 119 and the power cable 121 of the neck 140 may be bundled together and electrically insulated, for example, via a protective shroud made of rubber or a thermoplastic material. In some embodiments, the connection interface 141 may comprise a conductive mating interface to connect conductive elements (e.g., conductive strands, cable, wire, etc.) of the power cable/gas supply lead 118a and conductive elements (e.g., conductive strands, cable, wire, or a tube) of the power cable 121 of the neck 140. The conductive elements and mating interface may be made of an electrically conductive material, for instance, copper or brass. Still referring to FIG. 4, the second portion 146 may define an opening 146a dimensioned to route the wire conduit 119 and the power cable 121 therethrough and between the cavity 140a of the neck 140 and an outer surface thereof. In this manner, the wire conduit 119 and the power cable 121 may be operatively connected to a contact tip 170, as discussed below. In some embodiments, the first portion 144 may define the opening 146a (instead of the second portion 146).

The cavity 140a of the neck 140 may be configured so that it redirects the converging laser beam exiting the collimator lens assembly 150 in another direction. For this purpose, the neck 140 may comprise optical elements therein to redirect the laser beam. In the embodiment shown, the neck 140 includes a reflective mirror 148 therein, oriented in a direction defining a non-zero angle with the longitudinal axis LA1. In this manner, the mirror 148 may be configured to redirect the laser beam (irradiating upon its reflective surface) in a direction substantially parallel to a longitudinal axis LA2 of the second portion 146 of the neck 140. As such, the neck 140 may be configured to redirect an optical axis OA of the laser beam in a manner that is substantially parallel to a longitudinal axis LA2 of the second portion 146.

The second portion 146 of the neck 140 may also include a nozzle 180 with a gas diffuser 182 therein. The gas diffuser 182 may be operatively connected to an external gas supply source via the gas supply lead 123 and the utility cable bundle 117, and configured to supply and distribute shielding gas around the weld W, e.g., to prevent contamination of the weld W by atmospheric elements. The gas diffuser 182 may define an internal bore (shown via dotted lines) dimensioned to allow the laser beam to pass therethrough without obstructing the path of the laser beam toward the weld W. Further still, the nozzle 180 may be shaped and dimensioned to direct the shielding gas exiting the gas diffuser 182 toward the weld W.

A protective cover lens 184 (e.g., cover glass) may be disposed near or at a distal end of the second portion 146 to prevent contamination of the enclosure 151. In addition, an insulator may be disposed near or at a distal end of the second portion 146, (for example, PVC, teflon, heat shrink insulation, epoxy coating, a ceramic insulator, and the like).

A contact tip 170 may be operatively connected to the wire conduit 119 and the power cable 121 exiting the opening 146a. The contact tip 170 may define an internal bore dimensioned to receive the welding wire supplied via the wire conduit 119 therethrough, and direct the welding wire toward the weld W. The contact tip 170 may also be configured to receive current supplied via the power cable 121 to facilitate a hot wire laser welding process or a robotic GMAW welding process, as discussed below. For this purpose, the contact tip 170 may be made from a conductive material, for example, copper or brass.

As shown in FIG. 4, the contact tip 170 may be mounted to the second portion 146 of the neck 140 such that welding wire exits the contact tip 170 along an axis WA that defines a convergence angle ∞ with the optical axis OA of the laser beam exiting the second portion 146. The convergence angle ∞ may be between about 3 and 60°, for example, or between about 10° and 25° as non-limiting examples. The convergence angles enabled via the various examples of laser welding torches of the present disclosure engender criticality, inasmuch as they enable omnidirectional path movement and omnidirectional rotation, e.g., such that a rotation or movement of the laser beam (e.g., via manipulation of the robot arm/wrist) will result in a laser beam placement that coincides with a wire placement point on the weld.

Furthermore, the laser welding torch 120 of the present disclosure is versatile since it enables robotic GMAW welding, cold wire robotic laser welding, hot wire robotic laser welding, and autogenous laser welding. In some embodiments, the laser beam is applied to the weld concurrently with a GMAW arc (Hybrid-Laser-Arc-Welding, HLAW). In some embodiments, to facilitate a robotic GMAW welding process, the power source 80 (FIG. 2) current setting may be adjusted to supply a welding current to the contact tip 170 (via the utility cable bundle 117 and the power cable lead 121) to establish a welding arc between welding wire exiting the contact tip and the weld W. In other embodiments, laser welding torch 120 may facilitate a hot wire laser welding process, wherein the power source 80 (FIG. 2) current setting is adjusted to supply a preheating current to the contact tip 170 to resistively preheat the welding wire (below or near its melting point), while the laser beam (emitted from the second portion 146 of the neck 140) establishes a molten weld puddle at the site of the weld W. In other embodiments, the laser welding torch 120 may be operated to facilitate a cold wire laser welding process, such that the contact tip 170 will not preheat the wire it directs toward the weld, i.e., such that the contact tip 170 will not receive current from the power source 80. Further still, in some embodiments, the laser welding torch 120 may facilitate an autogenous welding process wherein the laser beam is directed to the weld W to melt or fuse two work pieces together (without welding wire/filler metal). In this manner, it should be understood that the laser welding 120 of the present disclosure is versatile insofar as it enables multiple welding processes to be performed via one torch. In various embodiments, the torch transitions between these welding modes without replacing or mechanically altering the housing, neck, optics, contact tip, wire conduit, or power cable.

In the illustrated example, the utility cable bundle 117 (comprising the wire conduit 114 and the power cable/gas supply lead 118a) is routed through the housing 130 to a connection interface 141 in the neck 140. It is contemplated that the cable bundle 117 may be externally routed and secured to an exterior surface of the housing 130. Further still, in some embodiments, it is contemplated that the wire conduit 119 and power cable 121 may be externally routed and secured to an exterior surface of the neck 140. Moreover, it is contemplated that gas supply lead 123 may be externally routed and secured to an exterior surface of the neck 140, for instance, in embodiments wherein the second portion 146 includes an external gas diffuser instead of a gas diffuser therein. In this manner, it should be appreciated that a variety of configurations may fall within the scope of the present disclosure. For example, in some embodiments, at least one of the wire conduit, the fiber optic cable, the gas line, the power cable, the coolant lines, or the sensor leads is routed along an exterior surface of the housing or the neck and is secured thereto by a mount, clip, strap, or shroud.

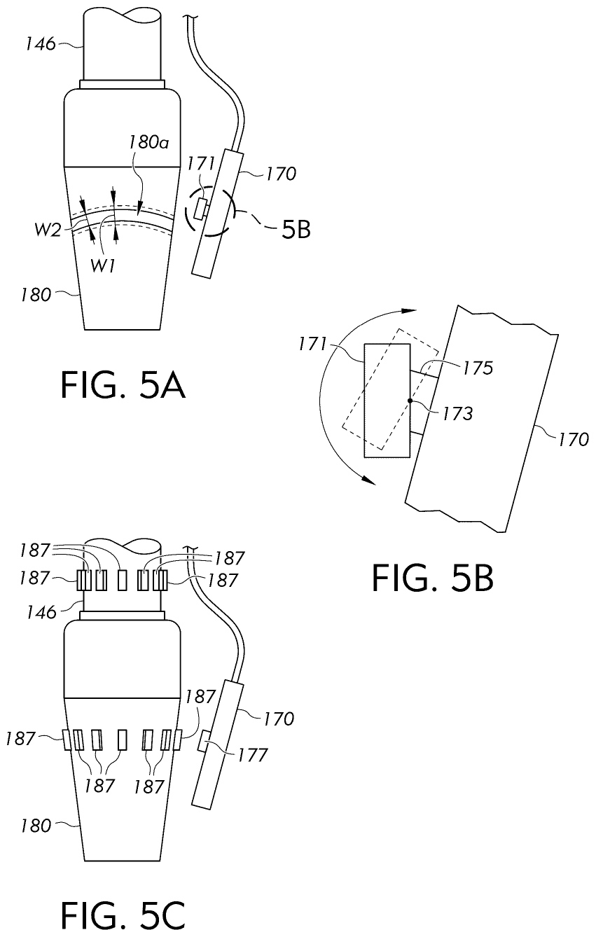

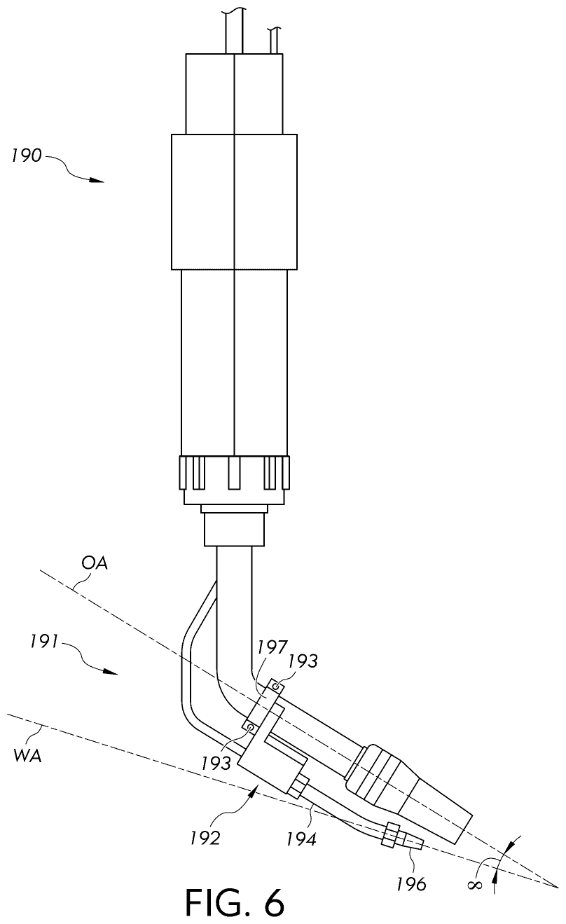

In the embodiment of FIG. 4, the contact tip 170 is mounted to an exterior surface of the nozzle 180, for example, via a suitable fastening means, e.g., a set screw, a clip, a snap fit connection, or any other suitable example of a fastening means described herein. It is also contemplated that the contact tip 170 may be integrally formed with the nozzle 180 to define a fixed convergence angle ∞ between the optical axis OA and the wire delivery axis WA. In some embodiments, there may be a plurality of nozzles with contact tips integrally formed therewith, wherein each nozzle defines a respective convergence angle ∞. For instance, a first nozzle may include a contact tip that defines a convergence angle of about 5°, whereas another nozzle may define a convergence angle of about 10°. This may be desirable, if, for example, certain applications were better suited for a particular convergence angle than others. In the embodiment shown, the contact tip 170 is configured to feed welding wire into the weld W from an upper side of the nozzle 180. In other embodiments, the contact tip 170 may be configured to feed the welding wire into the weld from a lower side of the nozzle 180 (see, e.g., FIG. 6), or from a lateral side (between the upper and lower sides). In some embodiments, it is contemplated that a position of the contact tip 170 relative to the optical axis may be adjusted, for example, by relocating it about an exterior surface of the nozzle 180 or about an exterior surface of the second portion 146. For instance, referring to FIG. 5A, the nozzle 180 may define a slot 180a (e.g., a T-slot) extending around a circumference of the nozzle 180, and the contact tip 170 may include a mating protrusion 171 (e.g., a T-nut or bolt) depending therefrom and dimensioned to be received by the slot 180a so that the contact tip 170 may be repositioned around the circumference of the nozzle 180 at a plurality of different locations thereon. In the embodiment shown, the slot 180a defines a first width W1 (shown via dotted lines) below an exterior surface of the nozzle 180 that is dimensioned to receive the mating protrusion 171 therein. The slot 180a also includes a second width W2 defining the slot opening that is smaller than the first width W1 to prevent the mating protrusion 171 from disengaging the slot 180a. It is contemplated that the slot may have an access opening (wherein the first and second width W1 and W2 are the same) to allow the mating protrusion to be received by the slot, thereby mounting the contact tip 170 to the nozzle 180.

As shown in FIG. 5B, in some embodiments, the mating protrusion 171 may be hinged to the contact tip 170 via a mount 175 disposed on an exterior surface of the contact tip 170 such that the orientation of the contact tip 170 may be adjusted by rotating the contact tip 170 about a pivot 173 connecting the mating protrusion 171 to the mount 175.

Yet, other configurations are contemplated. For instance, referring to FIG. 5C, the contact tip 170 may include a mount 177 depending therefrom configured to removably attach to a mating mount 187 on an exterior surface of the nozzle 180. It is contemplated that the mount 177 may be removably attached to the mount 187 of the nozzle 180 via any suitable fastening means, for example, via set screws, resilient snaps or clips, a tongue and groove configuration, magnets, etc. In some embodiments, the mounts 187 of the nozzle 180 may embody openings, and the mounts 177 on the contact tip 170 may embody protrusions configured to be snapped into or otherwise received the openings of the nozzle 180. In some embodiments, the mounts 187 may be disposed upstream on an exterior surface of the second portion 146 of the neck, as shown in FIG. 5C. Likewise, the slot 180a shown in FIG. 5A may be disposed upstream on an exterior surface of the second portion 146.

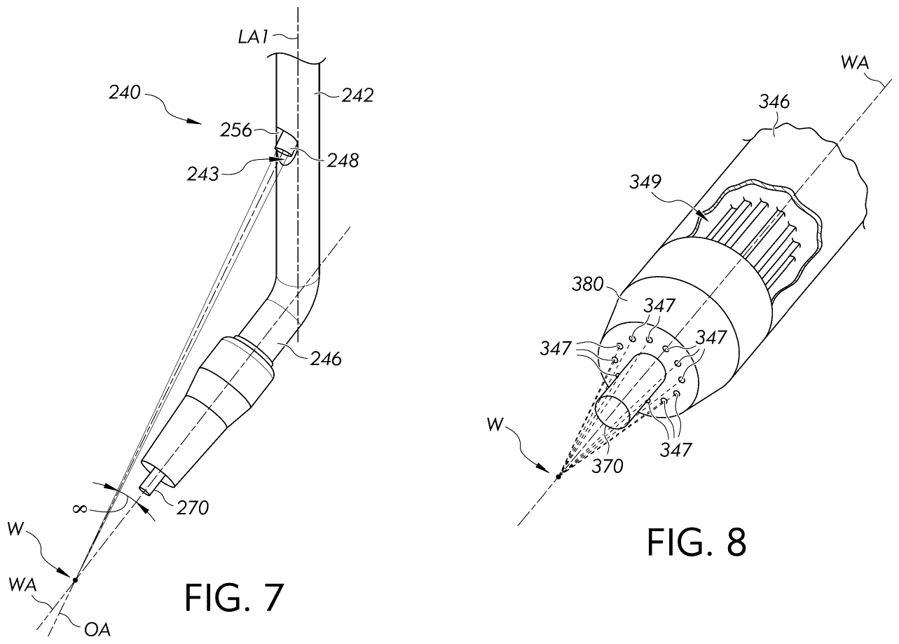

Turning to FIG. 6, another example of a robotic laser welding torch 190 is shown. In this embodiment, the robotic laser welding torch 190 includes a neck 191 comprising a mount 192 configured to support the contact tip 196 via a rigid tube 194 extending between the contact tip 196 and the mount 192. The rigid tube 194 may embody an insulated, conductor tube configured to supply current from the power cable (e.g., 121 in FIG. 4) to the contact tip 170. The mount 192 may include a collar 197 configured to rotate about a circumference of the neck 191 and be secured thereto via one or more fasteners extending into one more openings 193 spaced apart about a circumference of the collar 197. For example, one or more set screws may be utilized for this purpose. Although it is contemplated that other fastening means may be used, for example, a ratchet mechanism wherein the collar 197 comprises a pawl configured to engage one of a plurality of teeth disposed about a circumference of the neck 191, or any other example of a suitable fastening means described herein. In this manner, the mount 192 may be rotated about a circumference of the neck 191 via the collar 197 to reposition the location of the tip 196 (and therefore the wire delivery axis WA) relative to the optical axis OA, while maintaining a reduced convergence angle ∞ therebetween between about 3° and 60°, for example about 10° or about 20°. In some embodiments, the collar 197 may comprise two halves that are hinged together, wherein an interior surface of each half includes a high friction inlay (e.g., rubber or silicon) to grip the neck 191 when the halves are brought together and secured, thereby compressing the high friction inlay against the neck 191 to increase friction, Turning to FIG. 7, a partial view of an example of a neck 240 according to another embodiment is shown. The neck 240 defines an opening 243 near a juncture of the first portion 242 and the second portion 246 for irradiating a laser beam therethrough. For this purpose, the neck 240 may include an optical element 248 therein (e.g., a mirror) that is configured to redirect the laser beam emitted from the laser optics assembly (e.g., 150 in FIG. 4) toward the weld W along an optical axis OA. A protective cover lens 256 (e.g., cover glass) may be disposed over the opening 243 to prevent contamination of the internal optics from the external environment), while providing a transparent passage for the laser beam to pass through. In addition or alternatively, an gas flow device (e.g., a nozzle or air knife) may be arranged adjacent to the opening 243 to direct a high-velocity air stream across the opening to prevent contaminants from the external environment from entering the neck 240.

In this embodiment, the second portion 246 of the neck 240 includes a contact tip 270 at a distal end thereof configured to supply welding wire and/or current to a weld W along a wire delivery axis WA. For this purpose, the contact tip 270 may be operatively connected to a wire conduit and a power cable lead as discussed above to facilitate a cold wire laser welding process, a hot wire laser welding process, or a robotic GMAW welding process (wherein current supplied to the contact tip 270 establishes an arc between welding wire exiting the contact tip 270 and the weld to establish a molten weld puddle. In the embodiment shown, the opening 243 is formed in the first portion 242 of the neck near a juncture of the first and second portions 242 and 246. It is contemplated that the opening may be in different locations along the longitudinal axis LA1 of the first portion 242 such that the convergence angle between the optical axis OA and the wire delivery axis WA may be between about 3° and 15°, for example, about 10°.

Turning to FIG. 8, a partial view of a second portion 346 of a neck according to another embodiment is shown. In this embodiment, a plurality of optical fibers 349 (e.g., quartz fiber strands) are extended through the second portion 346 and are operatively connected to a fiber optic cable (e.g., 116 in FIG. 4) to transmit laser beams through optical openings or apertures 347 extending through a distal end of a nozzle 380. The optical apertures 347 may be oriented and equally spaced about a wire delivery axis WA such that the optical apertures 347 respectively irradiate laser beams that converge at a weld W. Each optical aperture 347 may include a protective cover lens (e.g., cover glass) thereon to prevent contaminants from entering the second portion 346 of the neck. In the embodiment shown, the second portion includes a contact tip 370 configured to direct welding wire toward the point of convergence (i.e., laser beam convergence) at the weld W. The contact tip 370 may be operatively connected to a wire conduit and a power cable lead as discussed above to facilitate a cold wire laser welding process, a hot wire laser welding process, a robotic GMAW welding process (wherein the current supplied to the contact tip 370 establishes a welding arc between welding wire exiting the contact tip and the weld W), or a HLAW process. In this embodiment, multiple laser beams are irradiated at respective optical axes converging with a wire delivery axis WA at the weld W. Because the laser beams and the welding wire emitted from the same structure (e.g., through a distal end of the nozzle 380), it is possible to maintain a reduced convergence angle between the laser beams and the wire delivery axis that is between about 2° and 25°, for example, about 7° or about 10°, for example.

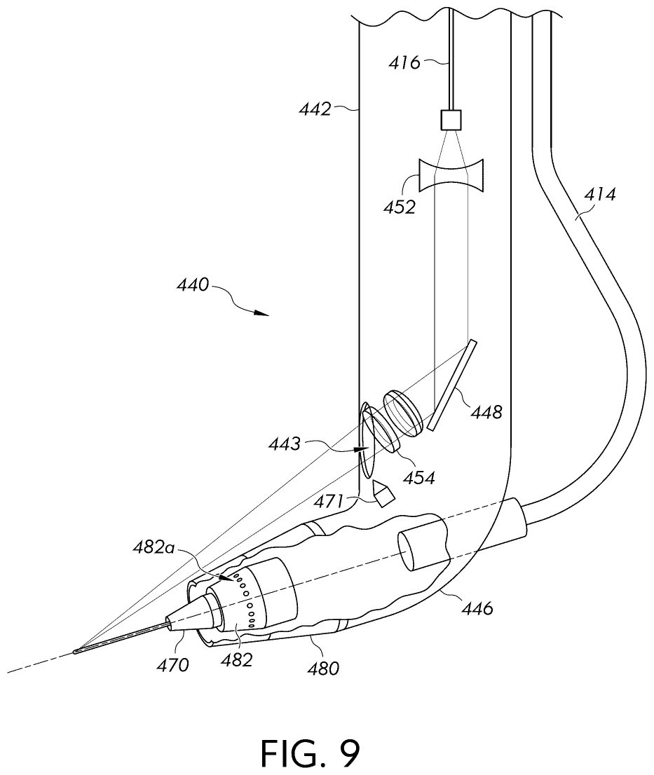

Turning to FIG. 9, a partial view of an example neck 440 according to another embodiment is shown. In this embodiment, the neck 440 defines an opening 443 near a juncture of the first portion 442 and the second portion 446 for irradiating a laser beam therethrough. For this purpose, the neck 440 may include an optical element 448 therein (e.g., a mirror) that is configured to redirect a laser beam emitted from a collimation lens 452. In this embodiment, the collimation lens 452 is configured to direct the laser beam toward the optical element 448, such that the optical element 448 redirects the laser beam toward the focusing lens 454 before the laser beam is directed through the opening 443.

A gas flow device 471 (e.g., a nozzle or air knife) may be disposed adjacent to the opening 443 to direct a high-velocity air stream across the opening 443 to prevent contaminants from the environment from entering the neck 440. In addition or alternatively, a protective cover lens (e.g., cover glass) may be disposed over the opening 443 to prevent contamination, while providing a transparent passage for the laser beam to pass through. In this embodiment, a wire conduit 414 is externally routed along an outer surface of the neck 440 and connected to a contact tip 470 at a distal end of the second portion 446. It is contemplated that the wire conduit 414 may be internally routed and connected to the contact tip 470. A diffuser 482 is disposed behind the contact tip 470 and configured to receive and retain the contact tip 470 therefrom, while distributing shielding gas through openings 482a thereof. A nozzle 480 may be attached to a distal end of the second portion 446 to direct the shielding gas toward the weld.

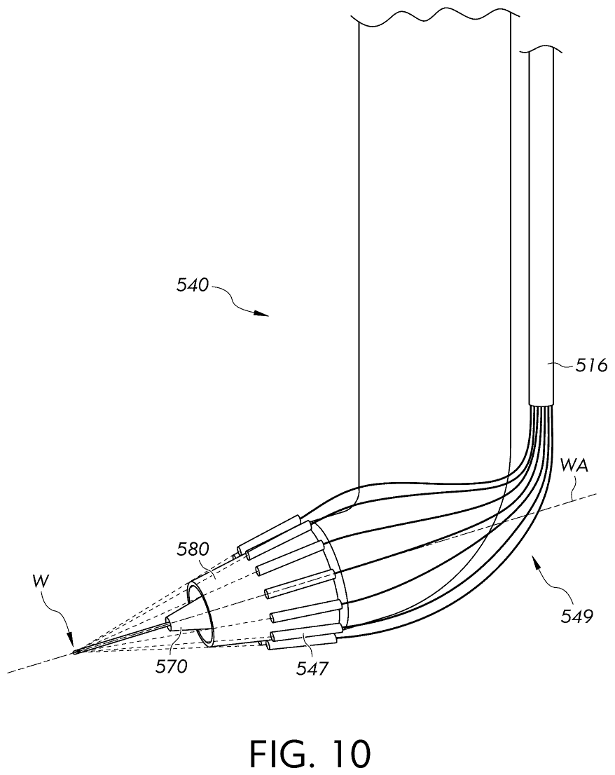

Turning to FIG. 10, a partial view of an example neck 540 according to another embodiment is shown. In this embodiment, the fiber optic cable 516 is externally routed along an outer surface of the neck 540. A plurality of quartz-glass fiber strands 549 extend from the fiber optic cable 516 and are respectively connected to optical apertures 547 equally arranged about a circumference of a nozzle 580. The optical apertures 547 may be dimensioned and equally spaced about a wire delivery axis WA such that the optical apertures 547 respectively irradiate laser beams that converge with the wire delivery axis WA at a weld site W. Each optical aperture 547 may include a protective cover lens (e.g., cover glass) to prevent contaminants from entering the neck 540. In the embodiment shown, the second portion 540 includes a contact tip 570 configured to direct wire toward the point of convergence between the laser beams and the wire delivery axis WA. Because the laser beams and the wire are emitted from the same structure, i.e., the nozzle (wherein wire is delivered through the nozzle, and the converging laser beams are emitted from an outer circumference of the nozzle), it is possible to reduce the convergence angle between the laser beams and the wire delivery axis WA to an angle between about 2° and 25°, or about 7°. The contact tip 570 may be operatively connected to a wire conduit and a power cable lead as discussed above to facilitate a cold wire laser welding process, a hot wire laser welding process, or robotic GMAW, or a HLAW welding process.

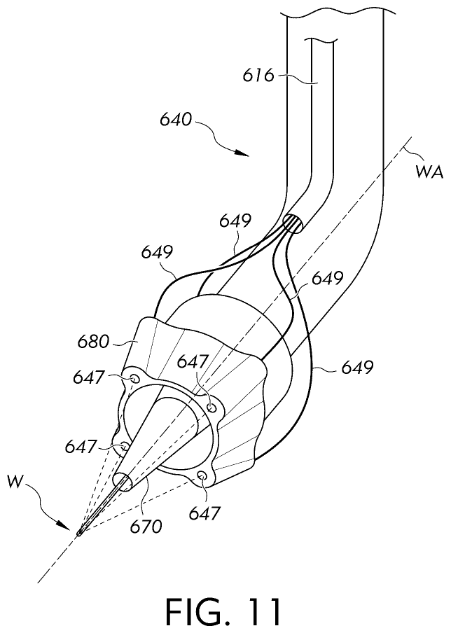

Turning to FIG. 11, a partial view of an example neck 640 according to another embodiment is shown. In this embodiment, the fiber optic cable 616 is externally routed along an outer surface of the neck 640. A plurality of quartz-glass fiber strands 649 extend from the fiber optic cable 616 and are connected to a nozzle 680 defining a plurality of optical apertures 647 equally spaced around a circumference of the nozzle 680. The optical apertures 647 are respectively connected to the fiber strands 649 and are configured to irradiate laser beams converging with the wire delivery axis WA at the weld W. In the embodiment shown, the neck 640 includes a contact tip 670 configured to direct wire toward the point of convergence at the weld W. The contact tip 670 may be operatively connected to a wire conduit and a power cable lead as discussed above to facilitate a cold wire laser welding process, a hot wire laser welding process, a robotic GMAW welding process, or a HLAW welding process.

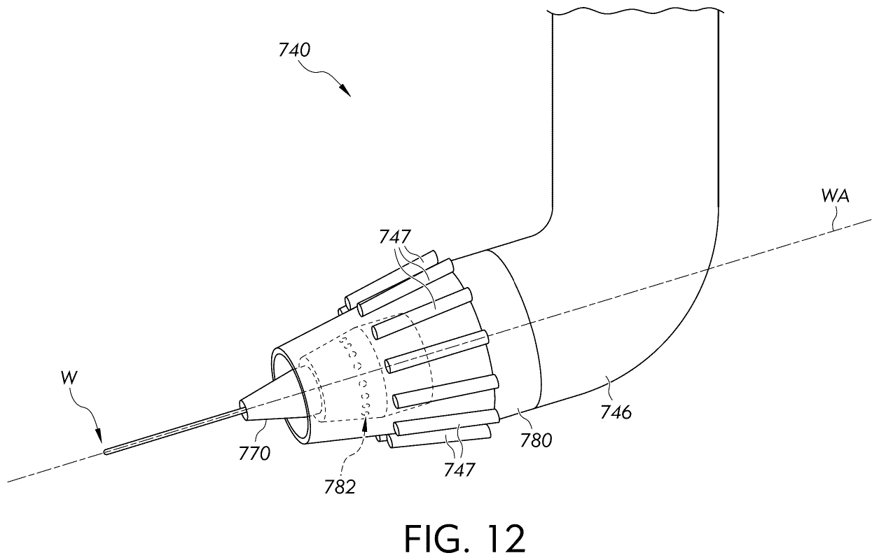

Turning to FIG. 12, a partial view of an example neck 740 according to another embodiment is shown. In this embodiment, the neck 740 includes a second portion 746 with a nozzle 780 attached to a distal end thereof. A plurality of optical apertures 747 are equally arranged around a circumference of a nozzle 780. The optical apertures 747 may be configured to respectively irradiate laser beams that converge with the wire delivery axis WA at a weld W. Each optical aperture 747 may include a protective cover (e.g., cover glass) at a distal end thereof to prevent contaminants from entering the neck 740. In the embodiment shown, the nozzle 780 includes a diffuser 782 therein defining a plurality of orifices 782a for distributing shielding gas around the weld site W. The plurality of orifices 782a may be dimensioned and equally spaced about a circumference of the diffuser 782.

The neck 740 also includes a contact tip 770 configured to direct wire toward the point of convergence between the laser beams and the wire delivery axis WA at the weld W. The contact tip 770 may be operatively connected to a wire conduit and a power cable lead as discussed above to facilitate a cold wire laser welding process, a hot wire laser welding process, or a robotic GMAW welding process (wherein current supplied to the contact tip 770 establishes a welding arc between welding wire exiting the contact tip and the weld W).

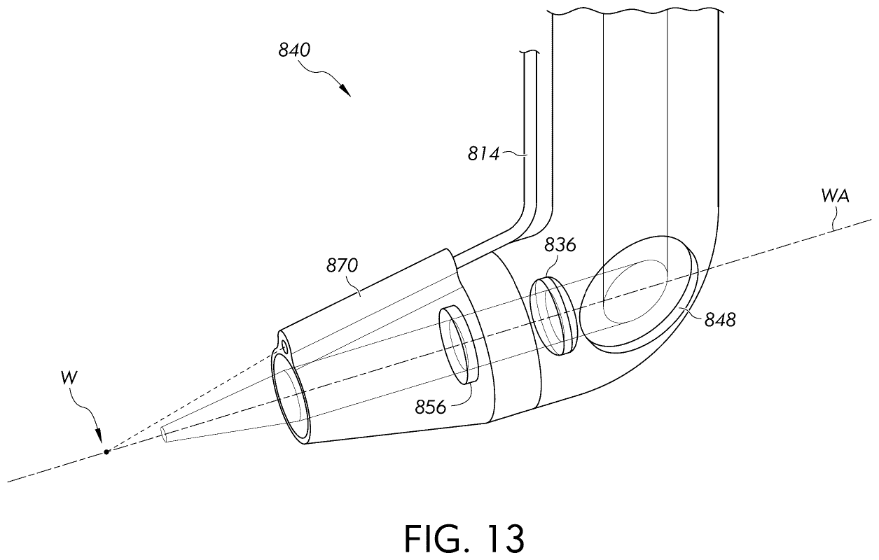

Turning to FIG. 13, a partial view of an example neck 840 according to another embodiment is shown. In this embodiment, the neck 840 includes an optical element 848 (e.g., a reflective mirror) configured to redirect a collimated laser beam toward the weld W. A focusing lens 836 may be disposed downstream of the optical element 848 to focus and/or realign the laser beam as needed. An input device may be provided (e.g., screws, sliders, or any other suitable input device) for repositioning the focusing lens 836 for this purpose. The wire conduit 814 is externally routed along the neck 840 to a contact tip 870. It is contemplated that the wire conduit 814 may be internally routed in other embodiments. In addition or alternatively, a protective cover lens 856 (e.g., cover glass) may be disposed downstream of the focusing lens 836 to prevent contamination of the neck 840, while providing a transparent passage for the laser beam to pass through.

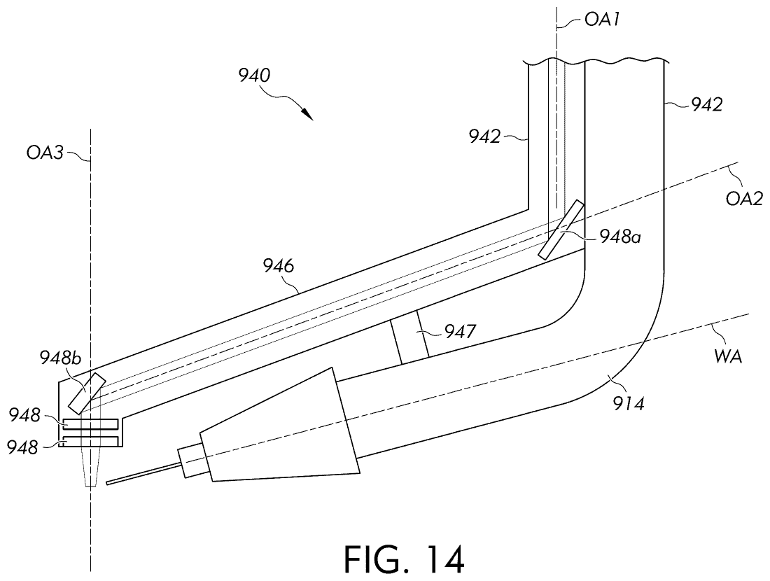

Turning to FIG. 14, another example of a neck 940 for a robotic laser welding torch is shown. In this embodiment, the neck 940 includes a plurality of optical elements for reflecting or otherwise redirecting the laser beam. A first optical element 948a (e.g., a reflective mirror) is disposed at a junction of the first and second portions 942 and 946, respectively, for redirecting a laser beam from a first optical axis OA1 to a second optical axis OA2. A second optical element 948b (e.g., a reflective mirror) is disposed at a distal end of the second portion 946 to redirect the laser beam from the second optical axis OA2 to a third optical axis OA3 that converges with the wire delivery axis at a weld W. It is contemplated that the optical element 948b may be re-oriented by the user to adjust the optical axis OA3, for example, via an adjustment means (e.g., any suitable example described herein). In this embodiment, the neck 940 includes a flexible conduit 914 for supplying utilities (e.g., gas, welding wire, and power) to a gas diffuser and contact tip at a distal end of the flexible conduit 914. A ratchet mechanism 947 may be provided to adjust a position of the flexible conduit 914 relative to the second portion 946 of the neck 940 (e.g., to raise or lower the flexible conduit 914 relative to the second portion 946).

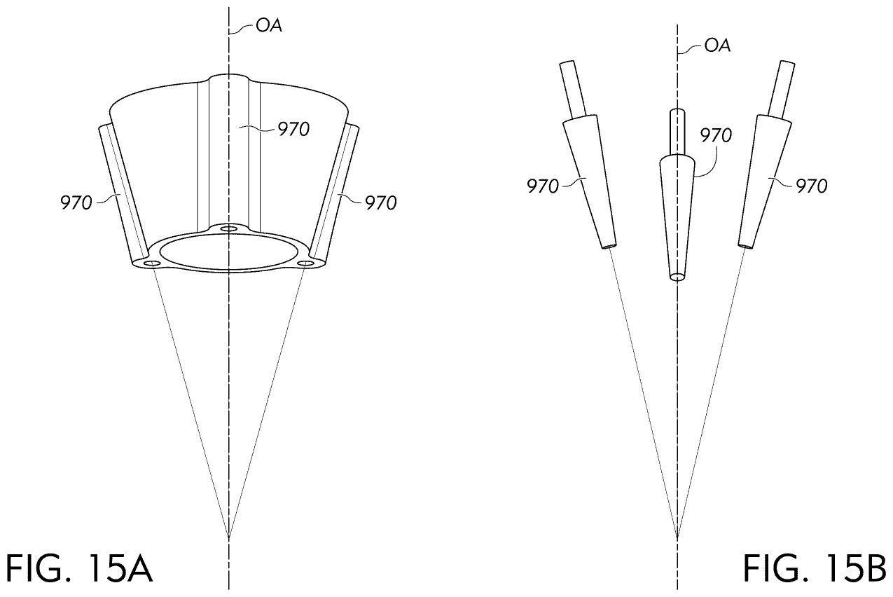

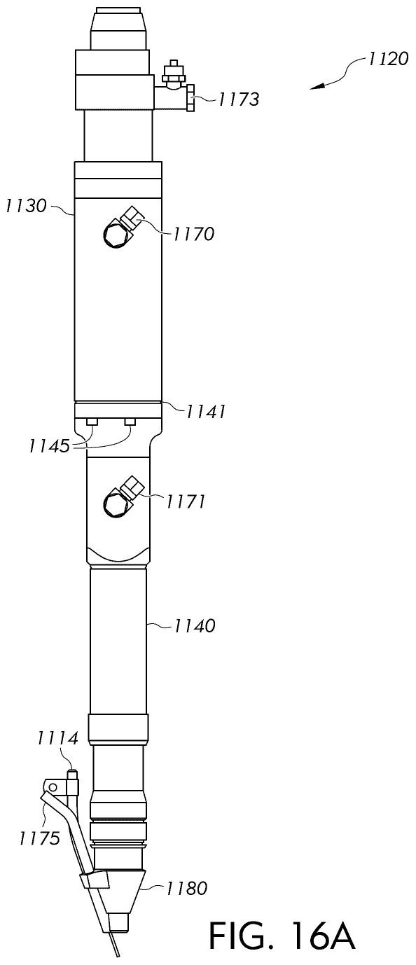

The laser welding torches described and shown above depict contact tips conveying a single welding wire to the site of a weld. It should be understood that other wire delivery arrangements may be provided. For example, turning to FIGS. 15A and 15B, a plurality of contact tips 970 may be equally spaced around an optical axis OA of a laser beam to increase the deposition rate of the welding process. In such embodiments, each contact tip 970 may be connected to a respective wire conduit for conveying welding wire to the site of the weld.

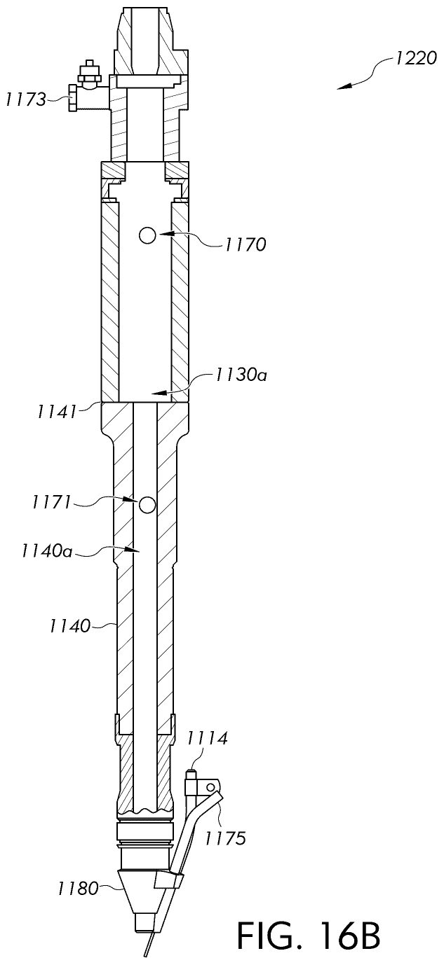

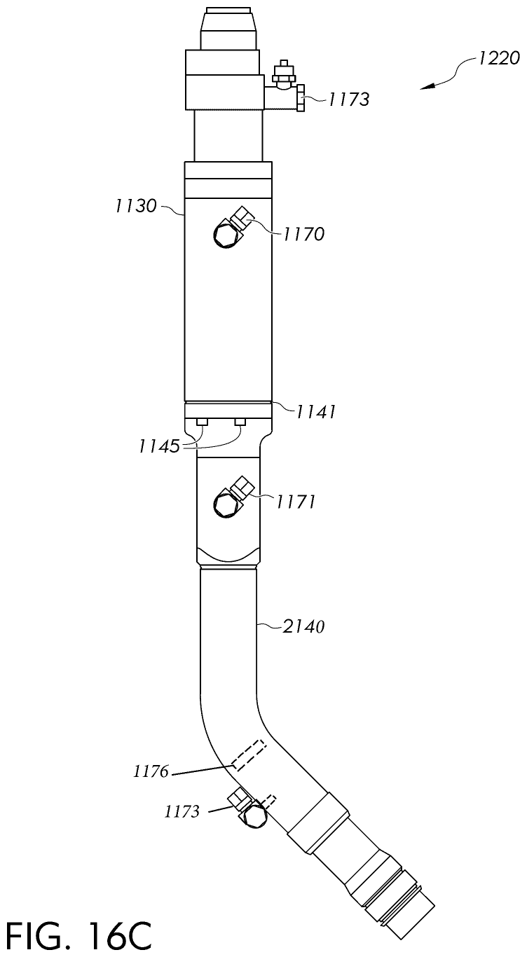

Turning to FIGS. 16A and 16B, another example of a robotic laser welding torch 1120 is shown. The robotic laser welding torch 1120 includes a housing 1130 and a neck 1140 that is removably attached to the housing 1130 via a connection interface 1141. In the embodiment shown, the neck 1140 is secured to the housing 1130 using fasteners 1145 (e.g., bolts) configured to secure the neck 1140 to the housing 1130 at the connection interface 1141. It is contemplated that the neck 1140 may be attached to the housing 1130 using other suitable examples of fasteners. For example, the neck 1140 may include a retaining collar (e.g., similar to collar 142 shown in FIG. 3) configured to engage a distal end of the housing 1130. In some embodiments, the retaining collar may define an interior thread pattern dimensioned to rotatably engage a mating thread pattern formed on an exterior surface of the housing 1130 to thereby attach the neck 1140 to the housing 1130. Other contemplated fastener structures include resilient snaps, clips, bayonet connectors, cam locks, clamps, dovetail slides, keyed joints, or any other suitable mechanical coupling.

Still referring to FIG. 16A, the torch 1120 may include a coolant inlet disposed above the housing 1130 and configured to receive coolant (e.g., water or any other suitable coolant) that is circulated through the housing 1130 and the neck 1140 via coolant lines. The coolant lines may include a coolant supply line and a coolant return line (not shown) routed through the torch to extract heat from internal components of the torch 1120, such as from the optical components (e.g., reflective mirrors), sensor leads (e.g., collision detection sensors), and/or communication leads (e.g., for a camera or scanner). To support coolant circulation, the torch 1120 may further include a coolant outlet (e.g., adjacent to coolant inlet 1173).

A purge inlet 1170 may be disposed on an exterior surface of the housing 1130 to receive a purge gas (e.g., dry air or nitrogen) supplied into the internal cavity 1130a (FIG. 16B). The purge gas pressurizes the cavity 1130a to inhibit the ingress of dust and/or debris that could contaminate the laser optics (e.g., collimation or focusing lenses), which have been omitted from FIG. 16B for clarity. The housing 1130 may be sealed using any suitable sealing technique (e.g., a suitable non-combustible and heat resistant sealant or o-rings) to maintain a desired positive internal pressure (e.g., about 5 psig, 10 psig, or 15 psig). A shield gas inlet 1171 may be disposed on an exterior surface of the neck 1140 to receive gas used to purge the cavity 1140a of the neck 1140 and prevent contamination from migrating upstream toward the laser optics. In some embodiments, nitrogen may be supplied through inlet 1171 to both purge the cavity 1140a and provide shielding around the weld. In such embodiments, the shielding gas may be directed through the nozzle 1180 of the torch 1120 to protect the weld from atmospheric impurities.

A mount 1175 may be removably attached to a distal end of the neck 1140 and may provide an interface for a wire conduit 1114 and/or a power cable (e.g., to supply current to a contact tip of the torch for performing hot-wire laser welding and/or conventional Gas Metal Arc Welding (GMAW)).

As shown in FIGS. 16A and 16B, the neck 1140 is aligned colinearly with the housing 1130. Such a configuration may be advantageous for performing welds inside pipes, frames, enclosed box structures, or other narrow or confined joints where a straight-line geometry improves accessibility.

Because the neck 1140 is removably attached to the housing 1130, it may be replaced with another neck configuration, such as neck 2140 shown in FIG. 16C. The replacement neck 2140 may include a first portion and a second portion that is skewed or angled relative to the first portion (e.g., similar to neck 140 of the first embodiment). The neck 2140 may be attached at the connection interface 1141 using fasteners 1145 or any other suitable fastening structure described herein. This interchangeability allows different torch neck geometries to be selected based on welding access requirements, weld position, tool center point (TCP) accuracy, collision avoidance considerations, or other application-specific factors.

As shown in FIG. 16C, another shield gas inlet 1173 may be disposed on an exterior surface of the neck 1140 near its distal end. The inlet 1173 may be configured to deliver gas to prevent dust and/or debris from entering the lower portion of the cavity 1140a (FIG. 16B) and from being carried toward upstream optical components of the laser welding torch, for example towards the focusing lens, collimation lens, or mirror. In some embodiments, inlet 1173 may be located downstream of a protective cover lens 1176 (e.g., cover glass), while in others it may be located upstream thereof. The inlet 1173 may supplement or replace the purge function of inlet 1171. In some embodiments, the shield gas may comprise nitrogen to purge the lower cavity of the neck 1140 and to shield the weld (e.g., upon exiting the nozzle 1180). In other embodiments, an argon-based shielding gas may be introduced into the inlet 1173 to shield the molten weld puddle from atmospheric contaminants during conventional GMAW applications. It is also contemplated the inlet 1173 may be utilized to supply a cooling gas through the distal end of the neck 1140 to dissipate heat generated during welding. In some embodiments, the length of the neck 1140 (FIG. 16B) may be adjustable to control the focal spot location of the emitted laser beam. For example, the neck 1140 may include a telescoping first portion (e.g., an outer sheath) that may be extended or retracted relative to a second portion (e.g., an inner sheath).

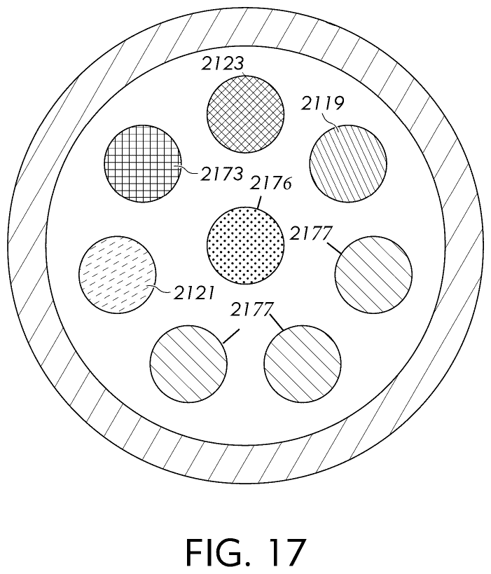

Turning to FIG. 17, a sectional view of a wrist of a through-arm robot (taken along line 17-17 of FIG. 2) is shown. In this embodiment, the wrist of the robot may house a cable bundle configured to supply the utilities and/or fiber optic line required by the robotic laser welding torch. These utilities may be routed internally through the robot arm. In some embodiments, the interface may include coolant supply and return lines 2121 and 2173 (to cool the laser optics), a gas line 2123 (e.g., for purge gas), a wire conduit 2119 (to deliver welding wire), and a fiber optic line 2176 for supplying the laser beam. Additional channels 2177 may be provided within the cable bundle for other utility lines, including for example a power cable to supply current to the contact tip, various sensor lines, and any other required control or communication leads.

The various examples of laser welding torches described herein are particularly beneficial insofar as they can provide the laser welding torch 120 a form factor (e.g., size, shape, and geometry) that is similar to other robotic welding torches, for example, a robotic GMAW welding torch including a gooseneck. In this manner, the laser welding torches of the present disclosure makes converting from a robotic GMAW welding process to a robotic laser welding process more attainable (e.g., without extensive reprogramming and/or fixture redesign, which otherwise would be required if converting from robotic GMAW welding equipment to a laser processing head shown in FIG. 1).

Moreover, the various examples of laser welding torches described herein provide a reduced convergence angle between a wire delivery axis and an optical axis, enabling omnidirectional movement and omnidirectional rotation.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or illustrative examples shown and described. Thus, this disclosure is intended to embrace alterations, modifications, and variations that fall within the scope of the appended claims, which satisfy the statutory subject matter requirements of 35 U.S.C. § 101. The above description of specific embodiments has been given by way of example. From the disclosure given, those skilled in the art will not only understand the general inventive concepts and attendant advantages, but will also find apparent various changes and modifications to the structures and methods disclosed. It is sought, therefore, to cover all such changes and modifications as fall within the spirit and scope of the general inventive concepts, as defined by the appended claims, and equivalents thereof.

What is claimed:

1. A laser welding torch for a robot comprising:
a housing including a laser optics assembly therein, wherein the laser optics assembly is configured to irradiate a laser beam along a first axis; and
a neck attached to a distal end of the housing and including a first portion and a second portion that is skewed relative to the first portion, wherein the neck is configured to redirect the laser beam from the first axis to a second axis extending through the second portion.

2. The laser welding torch of claim 1, wherein the second portion includes a contact tip at a distal end thereof configured to direct welding wire to a weld along a wire delivery axis.

3. The laser welding torch of claim 1, wherein the neck is removably attached to the housing.

4. The laser welding torch of claim 1, wherein the laser optics assembly includes a collimation lens configured to convert a diverging laser beam into a collimated laser beam, and a focusing lens configured to adjust a spot size of the laser beam.

5. The laser welding torch of claim 4, wherein the housing includes a first input device configured to adjust a position of the collimation lens within the housing, and a second input device configured to adjust a position of the focusing lens within the housing.

6. The laser welding torch of claim 1, wherein the laser optics assembly comprises a protective enclosure, and wherein the protective enclosure comprises a replaceable cartridge and includes at least one of a collimation lens and/or a focusing lens therein.

7. The laser welding torch of claim 1, wherein the housing defines an internal cavity and includes a protective cover lens, wherein the protective cover lens is configured to prevent contamination of the internal cavity.

8. The laser welding torch of claim 1, wherein the housing includes a purge gas inlet in fluid communication with an internal cavity of the housing, and wherein the housing is sealed to maintain a positive internal pressure to inhibit dust and debris from contaminating the laser optics assembly.

9. The laser welding torch of claim 1, wherein the neck includes a retaining collar configured to engage a distal end of the housing to secure the neck thereto.

10. The laser welding torch of claim 1, wherein the neck includes an inlet configured to receive gas to purge a lower portion of the neck and/or to supply the gas through a nozzle located proximate a distal end of the neck to protect the weld from atmospheric contaminants.

11. The laser welding torch of claim 1, wherein the neck includes at least one reflective optical element therein configured to redirect the laser beam from the first axis to the second axis.

12. The laser welding torch of claim 1, wherein the neck includes a first reflective optical element configured to redirect the laser beam from the first axis to the second axis, and a second reflective optical element configured to redirect the laser beam from the second axis to a third axis.

13. The laser welding torch of claim 1, wherein at least one of a wire conduit, a fiber optic cable, a gas supply line, a power cable, a coolant line, or a sensor lead is routed along an exterior surface of the housing or the neck and is secured thereto by a mount, clip, strap, or shroud.

14. The laser welding torch of claim 1, further comprising a gas flow device configured to direct a gas flow across at least one of an optical opening, a cavity of the housing, or a cavity of the neck to inhibit ingress of contaminants into at least one of the cavity of the housing or the cavity of the neck.

15. A welding torch comprises:
a housing defining an internal cavity with at least one optical element therein, wherein the at least one optical element is configured to irradiate a laser beam therefrom; and
a neck removably attached to the housing, wherein the neck is configured to direct the laser beam toward a weld.

16. The welding torch of claim 15, wherein the neck is aligned colinearly with the housing along a longitudinal axis of the welding torch.

17. The welding torch of claim 15, wherein the neck includes a bent portion configured to supply welding wire to the weld.

18. The welding torch of claim 15, wherein the neck comprises a first portion and a second portion that may be extended or retracted relative to the first portion to vary a focal position of the laser beam at the weld.

19. The welding torch of claim 15, wherein the neck further comprises a contact tip configured to direct welding wire to the weld and apply current thereto.

20. The welding torch of claim 19, wherein the contact tip is removably attached to the neck via a mount, and wherein the mount is configured to be repositioned about a circumference of the neck.

21. The welding torch of claim 15, wherein the neck includes at least one of a mirror or focusing lens therein.

22. The welding torch of claim 15, wherein the neck comprises:
a wire conduit, and
a contact tip configured to direct welding wire supplied via the wire conduit toward the weld.

23. The welding torch of claim 15, wherein the neck further comprises a power cable configured to supply current to a contact tip to preheat welding wire or establish an arc.

24. The welding torch of claim 15, wherein the neck defines an optical aperture such that the welding torch is configured to irradiate the laser beam through the optical aperture.

25. A torch for welding comprising:
a housing including an optical element therein, wherein the optical element is configured to direct a laser beam toward a weld; and
a neck removably attached to the housing, wherein the neck includes a contact tip at a distal end thereof, wherein the contact tip is configured to resistively preheat a wire or establish an arc between the wire and the weld.

26. The torch of claim 25, wherein the torch is configured to perform at least two of autogenous laser welding, cold-wire laser welding, hot-wire laser welding, hybrid-laser-arc-welding (HLAW), and gas metal arc welding (GMAW) by selectively controlling wire feed and electrical current to the contact tip.

27. The torch of claim 25, wherein the torch is configured to operatively connect to a power source and (i) deliver welding wire to a weld without preheating the welding wire to perform cold-wire laser welding, (ii) resistively preheat the welding wire to perform hot-wire laser welding, or (iii) establish an arc to perform gas metal arc welding (GMAW) and/or hybrid-laser arc welding (HLAW).
